(19) United States
(12) Patent Application Publication
(10) Pub. No.: US 2004/0128202 A1
(43) Pub. Date: Jul. 1, 2004

(54) Forecasting system and method

(76) Inventors: Martin L. Baum, Glen Ridge, NJ (US); Israel J. Rodriguez, Cypress, CA (US); Janice Kedzierski, Huntington Beach, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/618,106

(22) Filed: Jul. 10, 2003

Related U.S. Application Data
(60) Provisional application No. 60/395,545, filed on Jul. 12, 2002.

(51) Int. Cl. G06F 17/60

(52) U.S. Cl. 705/22

(57) ABSTRACT

A system and method for determining an allocation of goods. The system and method use historical sales information and associated historical trend information associated with the historical sales information to determine goods requirements for distribution centers and retailers.

### CROSS-REFERENCE TO RELATED APPLICATION(S)

This application claims the benefit of U.S. Provisional Application No. 60/395,545, filed Jul. 12, 2002 which is hereby incorporated by reference as if set forth in full herein.

### BACKGROUND OF THE INVENTION

The present invention relates generally to forecasting systems and methods, and more particularly to determining item demand using associated predictive information.

The demand for a particular good, or for a particular class of goods, is of great importance in effectively and advantageously filling market needs. Effective knowledge of future market demands allows for appropriate manufacture, placement, and pricing of goods. Absent effective predictive tools, inappropriate levels of goods may be manufactured, effectively made available to a consuming market, or priced disadvantageously to the manufacturer or distributor of the goods. The demand for some types of goods for the goods may be extremely volatile, as well as varying over time. For such goods inefficient ability to place the goods before the consumer may result in vast inefficiencies. Inefficiencies may result in waste of materials making up the goods, particularly for perishable or semi-perishable items. The inefficiencies may also result in the consumers being unable to obtain the goods at the desired times.

An example of some of some volatile goods are those related to the relief of symptoms related to the flu and common cold. Demand for these goods tends to be greater during winter time when respiratory illness among the population generally increases. However, the increase in respiratory afflictions varies year by year as to the time of greatest affliction, as well as varying by geographical area in the time, severity, and numbers of those afflicted. Accordingly, inefficiencies may result with inappropriate levels of goods suited for relief of symptoms for those afflicted throughout the winter and across varying geographical areas.

### BRIEF SUMMARY OF THE INVENTION

The present invention provides a predictive forecasting method and system.

### BRIEF DESCRIPTION OF THE DRAWINGS

FIG. 1 is a block diagram of a system in accordance with aspects of the invention;

FIG. 2 is a further block diagram of a system in accordance with aspects of the invention;

FIG. 3 is a flow diagram of a process in accordance with aspects of the invention;

FIG. 4 is a block diagram of a system adapted to perform processes associated with aspects of the invention;

FIG. 5 is a further flow diagram of a process in accordance with aspects of the invention;

FIG. 6 is a flow diagram of a process for performing periodic adjustment in the allocation of goods;

FIG. 7 is a flow diagram of a process for updating a retailer allocation of goods;

FIG. 8 is a flow diagram of a process for allocating a distribution center for allocation of goods; and

FIG. 9 is a flow diagram of a process for determining demand for goods.

### DETAILED DESCRIPTION

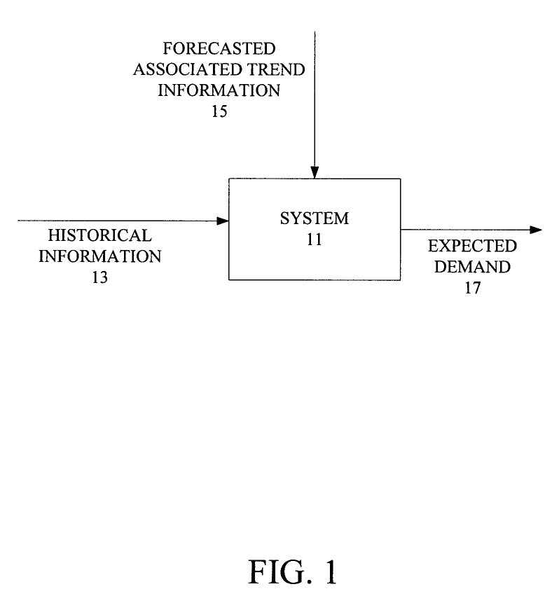

FIG. 1 is a block diagram of a system in accordance with aspects of the invention. In FIG. 1 a system 11 receives historical information 13. Historical information relates to historical sales levels of goods. In one embodiment, the historical information includes historical sales of goods over, for example, weekly periods in varying regions.

The system also receives forecasted associated trend information 15. The forecasted associated trend information relates to trends associated with, or related to, the demand for the goods. The system determines an expected demand 17 for the goods using the historical information and the forecasted associated trend information. In varying embodiments, the expected demand is calculated for a specific distribution network, a specific region, and in some embodiments a combination of both.

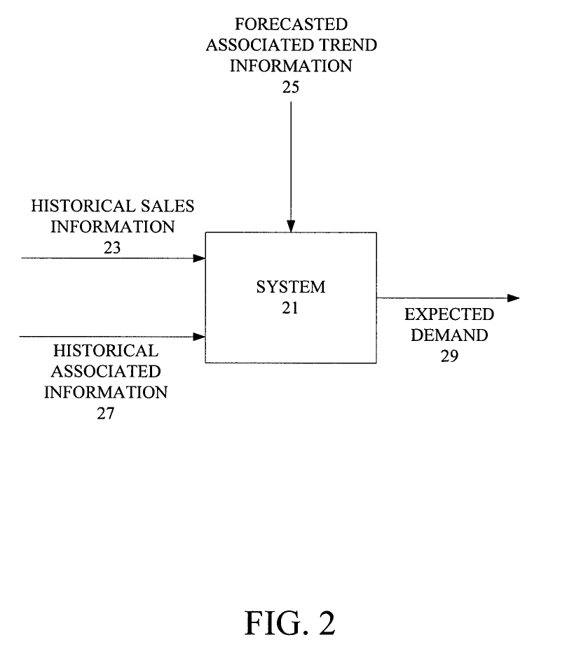

FIG. 2 illustrates a block diagram of a further system in accordance with aspects of the invention. A system 21 receives historical sales information 23 for a good or class of goods. The system also receives forecasted associated trend information 25, with the forecasted associated trend information related to the goods or class of goods. The system also receives further historical associated information 27. The further historical associated information is, in some embodiments, forecasted associated trend information for prior periods. In some embodiments, such as those for which the goods exhibit annual or seasonal changes, the previous forecasted associated trend information is that of a prior year or season. The system processes the historical sales information, the historical associated information, and a forecasted associated trend information to determine an expected demand 29 for a good or class of goods.

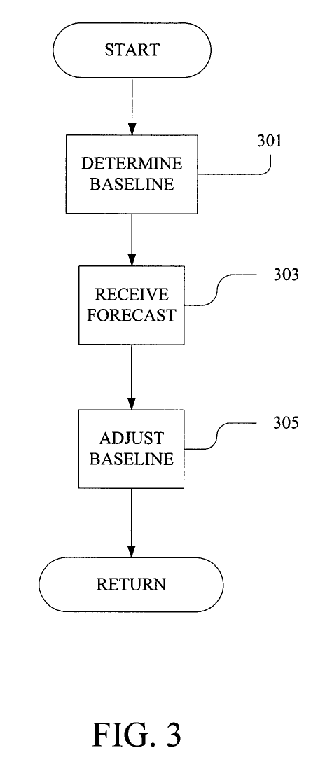

FIG. 3 is a flow diagram of a process for determining an expected demand for a good. In block 301 the process determines a baseline quantity for the good. The baseline quantity is, for example, the quantity of goods expected to be required at a given time at a particular retail location. In varying embodiments, the baseline may be for a class of goods, and the baseline may be for a particular retailer of the goods for a distribution center for the particular retailer or several retailers of the goods. The baseline quantity is an unadjusted expected quantity of the goods desired to be made available.

In block 303 the system receives a forecast. The forecast is a prediction of an occurrence associated with the use of the goods. In other words, the forecast is an estimate of varying circumstances which have a correlation with the demand for the goods. In block 305 the system adjusts the baseline to determine a new quantity of goods to be made available. The adjustment of the baseline is accomplished using the predicted forecast of events.

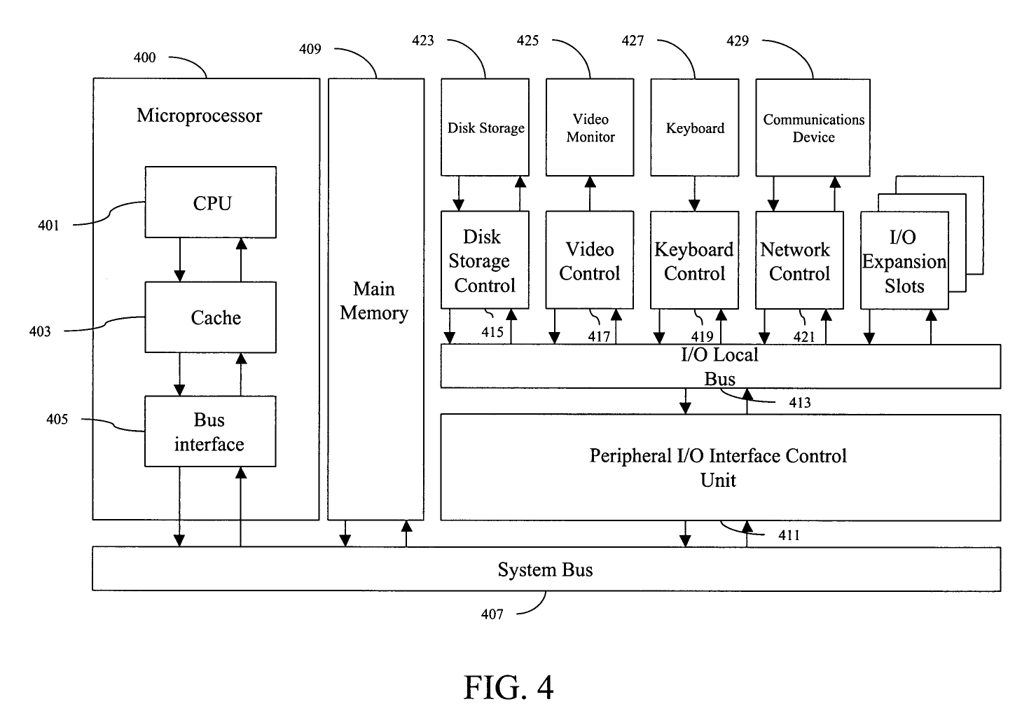

FIG. 4 illustrates a computer system adapted to perform the process of FIG. 3, as well as other processes in accordance with aspects of the invention. Microprocessor 400, comprised of a Central Processing Unit (CPU) 401, memory cache 403, and bus interface 405, is operatively coupled via system bus 407 to main memory 409 and I/O control unit 411. The I/O interface control unit is operatively coupled via I/O local bus 413 to disk storage controller 415, video controller 417, keyboard controller 419, and network controller 421. The network controller is adapted to allow software objects hosted by the general purpose computer to communicate via a network with other software objects. The disk storage controller is operatively coupled to disk storage device 423. The video controller is operatively coupled to video monitor 425. The keyboard controller is operatively coupled to keyboard 427. The network controller is operatively coupled to communications device 429.

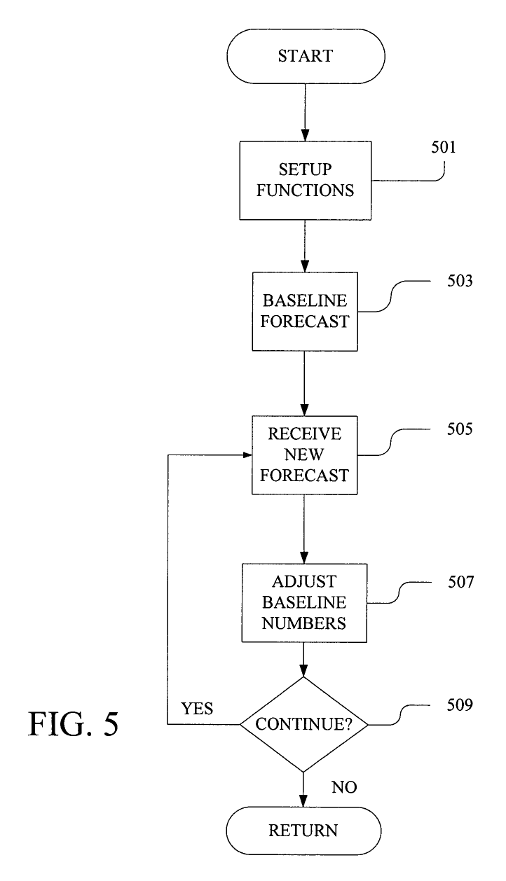

FIG. 5 is a flow diagram of a further process in accordance with aspects of the invention. In block 501 the process performs setup functions. In one embodiment the setup functions include generation of profiles for markets, retail chains, product groups, and items. In one embodiment the process receives information relating to each of these, and assigns constant factors for later use based on historical and statistical data. In one embodiment a market profile is generated through analysis of prior historical associated predictive information and associated unit consumption of a good. In one embodiment a retail chain profile includes percentage of unit sales held by the retailer in a market, the market composition of a distribution center maintained by the retailer, and the percentage of sales in a distribution center service area. In one embodiment a product group profile includes integration of a factor representing change in sales of a product in response to changes in the associated predictive information and a pivot factor for use in adjustments depending on the direction of change in the associated predictive information. In one embodiment an item profile includes a product group for the item and a factor indicating the possibility of out-of-stock conditions in prior years.

In the block 503 the process performs a baseline forecast. In various embodiments the baseline forecast is the expected week by week number of units expected to be sold by a retailer or a particular retail location, or provided to retail locations serviced by a distribution center or a particular retail location. In one embodiment the baseline forecast is determined using historical item level of consumption information through multiple regression analysis.

In block 505 the process receives a new forecast. The forecast is a prediction of an occurrence or occurrences associated in some way with the goods. In one embodiment, the associated predictive information is a level indicator of expected conditions nationally and in a particular geographical area during an upcoming week. For example, in one embodiment the associated predictive information is an expected number of persons afflicted by respiratory illness nationally and an alert status level for respiratory illness in a particular area. The level of respiratory illness in the area has a correlation with the demand for, for example, analgesic goods. In one embodiment the alert levels correspond to the number of people affected with a particular affliction, such as respiratory illness, in the upcoming week.

In block 507 the process adjusts the baseline numbers using the associated predictive information. In one embodiment the baseline numbers are adjusted for individual retail stores, distribution centers, and/or a retail chain.

In block 509 the process determines whether to continue. If the process is to continue the process returns to block 505 to receive new forecast information. Otherwise the process returns.

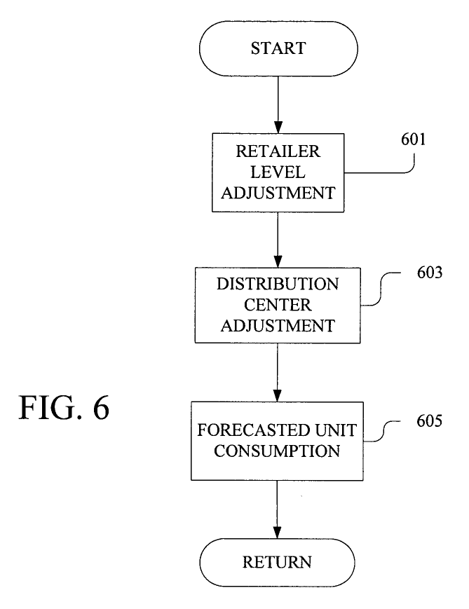

FIG. 6 is a flow diagram of a sub-process of adjusting a baseline allocation. Aspects of the sub-process are applicable to adjusting allocations at a retailer level and a distribution center level. In block 601 the process performs a retailer level adjustment. In one embodiment the retailer level adjustment is performed by determining the population expected to be affected by respiratory affliction in the upcoming week and multiplying that number by the historical number of sales for such a number of afflicted persons.

In block 603 the process performs a distribution center allocation adjustment. The process performs a distribution center adjustment allocation by comparing a factor associated with an expected market status with a prior market status level, and weighting the difference in status with the market's percent of retailer's sales. This calculation is performed for each market serviced by the distribution center, with the adjustments for each distribution market in each distribution center area summed to determine a distribution center adjustment.

In block 605 the process performs a forecasted unit consumption. The forecasted unit consumption is determined by modifying the baseline units by both the retailer level adjustment and distribution center adjustment. The process thereafter returns.

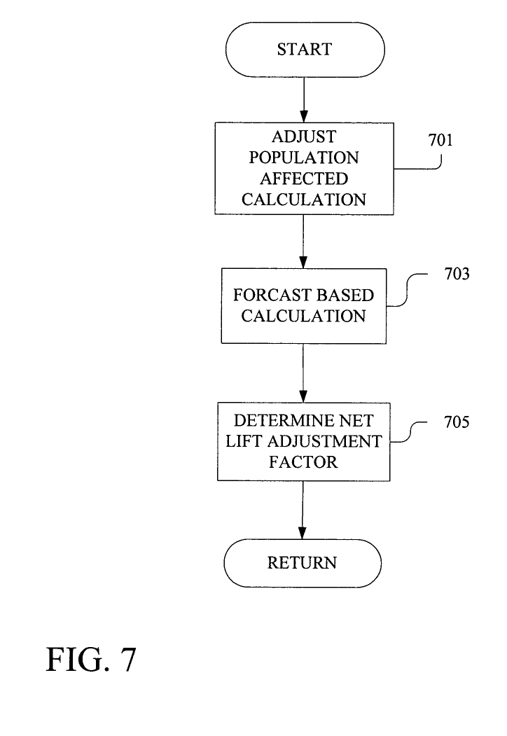

FIG. 7 is a flow diagram of a process for performing further retail level allocation adjustments. The adjustments are based on both changes in the population affected and the total number of population affected.

In block 701 the process performs a change in population affected calculation. Accordingly, in block 701 the process determines a forecasted number of units based on the net change in population affected with respiratory illness. The process determines the forecasted units by multiplying the baseline number of units with the net change in population affected. This calculation is further multiplied by a population affected adjustment factor. The population affected adjustment factor is a factor that is computed using historical and statistical information, and represents how purchase and/or use of a product or a product group reacts to changes in the population affected by illness.

In block 703 the process performs a forecast based on the total number of people affected calculation. The forecast based on population affected is calculated by multiplying a season to date average of unit sales for the population affected. This allows current sales for a good to be used to determine for any particular prior population affected with the illness, how many units they purchase. The forecasted units based on population affected is therefore the population affected multiplied by this season to date unit sales to population affected ratio.

In block 705 the forecast based on net changes in population affected and total population affected are blended to provide a net lift adjustment factor. The net lift adjustment factor is the average of the units calculated in blocks 701 and 703 plus a product group pivot factor and an out-of-stock opportunity percent. The product group pivot factor is used to make adjustments as to whether the percentage of population affected is increasing or decreasing. The out-of-stock opportunity percent is an adjustment calculated to insure that retailers do not go out of stock of the goods. The process then returns.

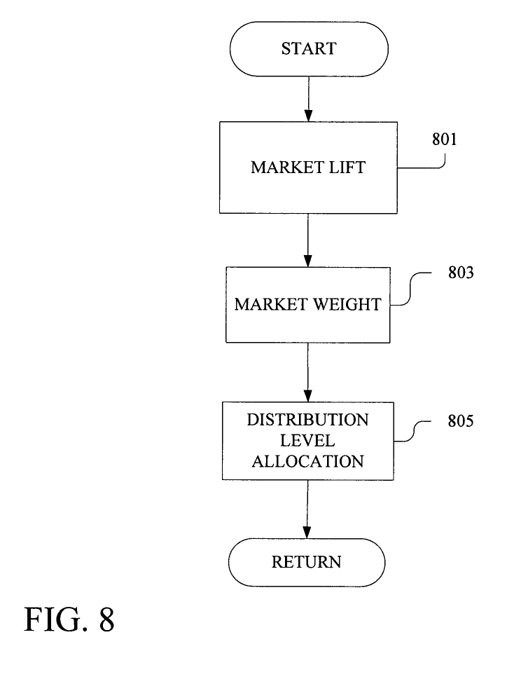

FIG. 8 is a flow diagram of a process for performing distribution center allocation adjustments. The distribution center level adjustments take into account information for each of the markets served by the distribution center, as well as market share for a retailer in each of those markets. In block 801 the process determines a market lift for each market. The market lift is determined, in one embodiment, by comparing a lift associated with the alert status of the market with a lift status associated with the market in the prior year. In block 803 the lifts are weighted by the percentage of the retailer's sales in each market. In block 805 the weighted net lifts are summed and an adjusted distribution center allocation is made based on the weighted net lifts. In one embodiment this is accomplished by adjusting an original distribution center allocation by the summed weight net lifts. In a further embodiment the distribution center allocations are a percentage of a retailer forecasted number of units of a good. Accordingly, in one embodiment the distribution center allocations are normalized, for example by multiplying a distribution center allocation by a ratio indicative of the expected change in total number of forecasted units for the good. As such, a circumstance, a unit allocation to a distribution center may be determined by multiplying a baseline number of units by a retailer level lift factor and a normalized distribution center allocation percentage. The process then returns.

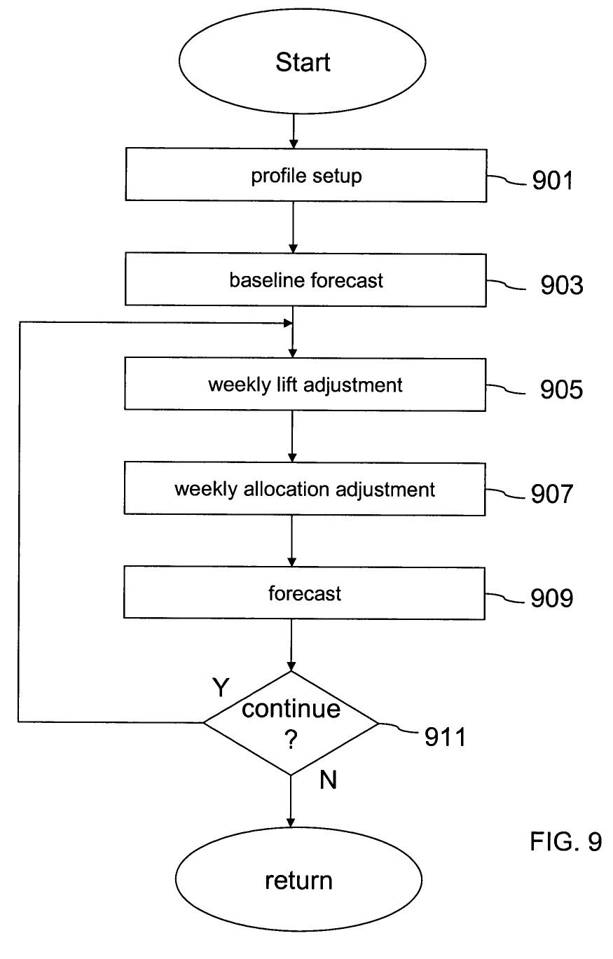

FIG. 9 is a flow chart of a process for determining weekly forecasts for demands for a good or goods which have a high correlation with external events. In some embodiments the goods are analgesics and the external event is the number of people afflicted with flu-like symptoms. As illustrated in FIG. 9, the process determines an item level forecast for a retail chain and its distribution centers, and includes performing a market/retail chain/product group/item profile setup, performing retail chain item level baseline forecasting, performing a weekly lift adjustment calculations, performing a weekly distribution center allocation adjustments, and performing retailer/item level forecast generation.

In block 901 the process performs a profile setup. Profile setup generally occurs as a part of a pre-season setup. Profile setup includes setting up profiles for each retail chain, product group, and item. The profiles collect and categorize relevant information used to generate a consumption forecast. In some embodiments each market is assigned a lift factor based on historical trends in market status (status being, for example, advisory, pre-alert and alert) versus change in unit consumption at the segment level. A retail chain profile is determined and includes the percent of unit sales by segment for each distribution center which a retailer operates. The market composition of each distribution center's service area, and the percent of unit sales by segment for each of the markets in which the retailer operates.

In various embodiments a product group profile is determined, and includes a population affected adjustment factor. The population affected adjustment factor is computed using historical trending and statistical that represents how a given product group reacts to changes in the population affected by an illness, which segment in the category the product group fits under. A product group pivot factor using historical consumption information along with statistical methodology is computed that represents a typical seasonal pivot factor for the product group. This factor will usually affect the forecast in one direction in the first half of the season and the opposite in the second half, creating a virtual pivot. The factor is represented as a percent. In some embodiments an item profile is determined, and includes which product group the item fits under and an out-of-stock opportunity percent which is based on the results of a retail audit conducted during the peak weeks of the previous season. An out-of-stock opportunity percent is calculated for each item by retailer.

In block 903 the process performs an item level baseline forecast. The baseline forecast for each item at the retailer level is generally generated during the pre-season setup process. Historical item level consumption is utilized to generate the baseline sales through multiple regression analysis.

In block 905 the process performs weekly lift adjustment calculations. Each week a lift adjustment is calculated for each retailer/item combination. In some embodiments calculating the lift is a three part sub-process. The sub-process determines a lift adjustment calculation based on a forecasted net change in population affected and a forecasted population affected. In a first part expected unit sales are calculated based on the expected change in the number of people affected with a given illness.

Forecasted Units(1)=[Baseline Units]*[Net Change (%) in Population Affected]*[Population Affected Adjustment Factor]

In a second part expected unit sales are calculated based on the actual forecast of people affected with a given illness.

Season-to-Date Unit Sales to Population Affected Ratio=Season-to-date average of [Unit Sales]/[Population Affected]values.

Forecasted Units(2)=[Population Affected]*[Season-to-Date Unit Sales to Population Affected Ratio].

In a third part a lift is calculated.

Average Units=([Forecasted Units(1)]+[Forecasted Units(2)]/2

Forecasted Lift=1+(([Average Units]−[Baseline Units])/[Baseline Units])+[Product Group Pivot Factor]+[Out-of-Stock Opportunity Percent].

In block 907 the process determines weekly distribution center allocation adjustments. A lift adjustment is calculated for each retailer/distribution center combination. This distribution center adjustment enhances the forecasting process by adjusting the distribution allocations in response to market level illness levels. Market level illness levels are based on status levels (for example, advisory, pre-alert, and alert) and are predicted based on the historical average number of weeks a market stays in a given status level. Calculating the allocation adjustments includes determining a net lift by market is calculated.

Net Lift=[Segment Lift Associated with Market Status Level This Year]−[Segment Lift Associated with Market Status Level Last Year]

The net lift is weighted based on the retail chains percent of sales by market. This step effectively weights the net lifts based on the percent of sales the retailer has in the given market.

Weighted Net Lift=[Net Lift]*[Market's Percent of Retailer's Sales]

The total weighted lifts are summed to the distribution center level.

Distribution Center Total Net Lift=Sum([Weighted Net Lifts]) for each market that the distribution center services. The new distribution center allocation is calculated by weighting the Total Net Lift for each distribution center based on its original allocation.

Calculation1=(OriginalAllocation*(1+LiftAdjustment))

Adjusted Distribution Center Allocation=Calculation1*(SUM(Original Allocations)/SUM(Calculation1s))

In block 909 the process determines a forecast. The Distribution Center/Item forecast is generated using the output from the above steps, in which

Forecasted Unit Consumption=[Baseline Units]*[Forecasted Lift]*[Adjusted Distribution Center Allocation]

The invention provides a forecasting method and system. Although the invention has been described in certain specific embodiments, it should be recognized that the invention comprises the valid claims and their equivalents supported by this specification.

What is claimed is:

1. A method using a computer of determining a goods requirement, comprising:
receiving historical information relating to historical sales levels of the goods;
receiving forecasted associated trend information relating to trends associated with demand for the goods; and
determining an expected demand for the goods using the historical information and the forecased associated trend information.

2. The method of claim 1 wherein the expected demand is determined for a specific distribution network.

3. The method of claim 1 wherein the expected demand is determined for a specific region.

4. The method of claim 1 further comprising receiving further historical associated information, the further historical associated information comprising forecasted associated trend information for a prior period.

5. The method of claim 4 wherein the forecasted associated trend information for a prior period is a prior season.

6. A method using a computer of determining an expected demand for a good, comprising:
determining a baseline quantity for the good;
receiving an estimate of circumstances which have a correlation with the demand for the good; and
adjusting the baseline quantity using the estimate of circumstances.

7. The method of claim 6 wherein the baseline quantity is the quantity of goods expected to be required at a given time at a particular retail location.

8. The method of claim 6 wherein the baseline quantity is the quantity of goods expected to be required for a distribution center of a particular retailer.

9. A method using a computer of determining an expected demand for a good, comprising:
performing setup functions;
determining a baseline forecast through multiple regression analysis using historical levels of consumption for the good;
receiving associated predictive information regarding the goods; and
adjusting the baseline forecast using the associated predictive information regarding the goods.

10. The method of claim 9 wherein the associated predictive information is an expected number of individuals afflicted with an illness and an alert status level for the illness.

11. The method of claim 10 wherein adjusting the baseline forecast comprises determining an average number of units by averaging the multiple of the expected number of individuals by historical number of sales corresponding to the expected number of individuals and the multiple of a net change in expected number of individuals and a population affected adjustment factor.

12. The method of claim 11 wherein adjusting the baseline forecast comprises using the average number of units, a pivot factor, and an out of stock opportunity percent.

13. A system for determining a goods forecast, comprising:
means for receiving historical information relating to historical sales levels of the goods;
means for receiving forecasted associated trend information relating to trends associated with demand for the goods; and
means for determining an expected demand for the goods using the historical information and the forecased associated trend information.
